(19) United States
(12) Patent Application Publication
(10) Pub. No.: US 2011/0093415 A1
(43) Pub. Date: Apr. 21, 2011

(54) CONTENT RECOMMENDATION APPARATUS AND METHOD

(75) Inventors: Young Ho RHEE, Seoul (KR); Hyun Joo Kang, Suwon-si (KR); Yeo Jin Kim, Suwon-si (KR); Il Ku Chang, Seoul (KR); Ju Youn Lee, Seongnam-si (KR)

(73) Assignee: SAMSUNG ELECTRONICS CO., LTD., Suwon-si (KR)

(21) Appl. No.: 12/815,851

(22) Filed: Jun. 15, 2010

(30) Foreign Application Priority Data
Oct. 15, 2009 (KR) 10-2009-0098447

(51) Int. Cl. G06F 15/18; G06N 5/02

(52) U.S. Cl. 706/12; 706/54

(57) ABSTRACT

A content recommendation apparatus and method are provided. The content recommendation apparatus may record user history information of a user of a personal communication terminal where a web browsing service or mobile communication is possible. The user history information may be used to generate preference information of the user. Based on the preference information, content may be recommended to the user through a display based on a category type of the content such that different types of content are visually differentiated on the display.

### CROSS-REFERENCE TO RELATED APPLICATION(S)

This application claims the benefit under 35 U.S.C. §119(a) of Korean Patent Application No. 10-2009-0098447, filed on Oct. 15, 2009, in the Korean Intellectual Property Office, the entire disclosure of which is incorporated herein by reference for all purposes.

### BACKGROUND

1. Field

The following description relates to a content recommendation apparatus and method, and more particularly, to a content recommendation apparatus that recommends content based on a status and/or a preference of a user controlling a terminal such as a personal computer (PC), or a mobile terminal.

2. Description of Related Art

Today, Internet communications and mobile terminals are quickly becoming necessities. Through the use of terminals, information retrieval through telephone communications, social activities, entertainments, and the like, may be diversely conducted such as through phone calls, e-mails, web browsing, instant messaging, and the like.

Users may spend a significant amount of time to retrieve desired information out of a flood of information provided on the Internet. Accordingly, users may spend a great deal of time searching for suitable contents by various desired activities, for example, by e-mail, messenger, online groups, shopping, entertainment, and the like.

Terminals used for various Internet communications may include rather small displays. Thus, service providers providing Internet services through web pages to terminals have been making a significant effort to provide information to a displays of limited size.

Because content provided by the service providers includes limitations such as keyword-based retrieval information, often times desired information of the users cannot be retrieved. In addition, personalized customized information cannot be provided even though the desired information of different users may be different from each other.

### SUMMARY

In one general aspect, there is provided a content recommendation apparatus, including a history information recording unit configured to record user history information of a user of a personal communication terminal that includes at least one of a web browsing service or in which mobile communication is possible, a recommendation content extracting unit configured to generate preference information of the user based on the user history information, and to extract recommended content based on the preference information, and a display unit configured to display the recommended content by category type based on the preference information of the user such that the recommended content is visually differentiated by category type.

The user history information may include at least one of a current time, a current location of the user, web log information, and phone log information.

The recommendation content extracting unit may extract the recommended content further based on a popularity of the recommended content with respect to a plurality of other users.

The category type may include at least one of event, group, friend, my stuff, followed, and inbox.

The category type may be provided by the personal communication terminal, or determined by the user.

The display unit may generate and display the recommended content in grids having different sizes based on the preference information.

The display unit may display a current location and a current time of the user.

The display unit may arrange the most recent recommended content in a rightmost area of the display, with respect to the other arranged recommended contents.

The content extracting unit may further extract recommended content that is similar to recommended content selected by the user, and the display unit may further display the similarly recommended content.

The display unit may displays the similarly recommended content in chronological order below a recommendation content grid.

In another aspect, there is provided a content recommendation method, including recording user history information of a user of a personal communication terminal that includes at least one of a web browsing service or in which mobile communication is possible, generating preference information of the user based on the user history information, extracting a recommended content based on the preference information, categorizing the recommendation content by category type, and displaying, on a display, the recommended content based on the preference information.

The user history information may include at least one of a current time, a current location of the user, web log information, and phone log information.

The extracting may extract the recommended content further based on a popularity of the recommended content with respect to a plurality of other users.

The category type may include at least one of event, group, friend, my stuff, followed, and inbox.

The category type may be provided by the personal communication terminal, or configured by the user.

The displaying may generate and display the recommended content in grids having different sizes based on the preference.

The displaying may display a current location and a current time of the user.

The displaying may arrange the most recent recommended content in a rightmost area of display, with respect to the other arranged recommended contents.

The extracting may further extract recommended content that is similar to recommended content selected by the user, and the displaying may further display the similarly recommended content.

The displaying may display the similarly recommended content in chronological order below a recommendation content grid.

In another aspect, there is provided a computer-readable storage medium having stored therein program instructions to cause a processor to execute a content recommendation method including recording user history information of a user of a personal communication terminal that includes at least one of a web browsing service or in which mobile communication is possible, generating preference information of the user based on the user history information, extracting a recommended content based on the preference information, categorizing the recommendation content by category type, and displaying, on a display, the recommended content based on the preference information.

Other features and aspects may be apparent from the following description, the drawings, and the claims.

### BRIEF DESCRIPTION OF THE DRAWINGS

FIG. 1 is a diagram illustrating an example of a content recommendation apparatus in an integrated communication environment.

FIG. 2 is a diagram illustrating an example of a content recommendation apparatus.

FIG. 3 is a table illustrating examples of web log types and contents of the web logs.

FIG. 4 is a table illustrating examples of phone log types and contents of the phone logs.

FIG. 5 is a table illustrating examples of fields based on preferences used in a preference information generating unit.

FIG. 6 is a diagram illustrating an example of recommended contents displayed on the display of a web browsing terminal.

FIGS. 7A and 7B are diagrams illustrating examples of recommended contents displayed on the display of a mobile terminal.

FIG. 8 is a flowchart illustrating an example of a content recommendation method.

Throughout the drawings and the detailed description, unless otherwise described, the same drawing reference numerals should be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein may be suggested to those of ordinary skill in the art. The progression of processing steps and/or operations described is an example; however, the sequence of steps and/or operations is not limited to that set forth herein and may be changed as is known in the art, with the exception of steps and/or operations necessarily occurring in a certain order. Also, description of well-known functions and constructions may be omitted for increased clarity and conciseness.

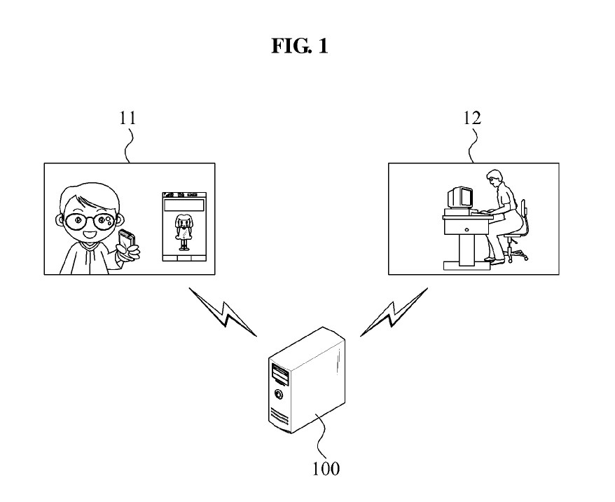

FIG. 1 illustrates an example of a content recommendation apparatus in an integrated communication environment. The content recommendation apparatus and method may recommend contents based on a behavioral log, for example, a web log, a call log, and the like, of a user. The behavioral log may be based on status information of the user, a social networking function of the user, and/or a function of recording and managing log history of the user.

Referring to FIG. 1, a user using the content recommendation apparatus 100 may be provided with recommended contents where a location, a time, a personal preference, and the like are reflected in a mobile communication terminal 11 or in a web browsing service terminal 12. When generating the recommended contents, the popularity of other users, the current location (place), the time, and the preference of an individual user of the content recommendation apparatus 100, and the like, may be considered.

The content recommendation apparatus 100 and method may base preference information of a user based on call-related log information in the mobile communication terminal as well as in the web browsing service terminal The content recommendation apparatus 100 and method may base preference information on use history of a user that is collected in various types of terminals in the integrated communication environment, to provide customized recommended contents for individual users.

The content recommendation apparatus 100 and method may flexibly provide contents by adjusting visual changes such as changes in sizes and colors in according to the size and type of the monitor of various terminals of users, thereby enabling a user to easily and rapidly recognize desired recommended contents.

As for the content recommendation apparatus and method under the integrated communication environment, the web browsing service terminal may include a terminal where web browsing is possible, for example, a computer terminal, a Public Switched Telephone Network (PSTN) terminal, a Voice over Internet Protocol (VoIP), a Session Initiation Protocol (SIP), a Megaco, a Personal Digital Assistant (PDA), an IP television (TV), a navigation terminal, and the like.

The mobile communication terminal may include, for example, a cellular phone, a Personal Communication Service (PCS) phone, a Hand-Held PC, a Code Division Multiple Access (CDMA) phone, a Wideband CDMA (WCDMA) phone, a Dual Band/Dual Mode phone, a Global Standard for Mobile (GSM) phone, a Mobile Broadband System (MBS) phone, a Digital Multimedia Broadcasting (DMB) phone, and the like.

Accordingly, the content recommendation apparatus may refer to a web browsing service terminal and/or a mobile communication terminal that are capable of providing web browsing services.

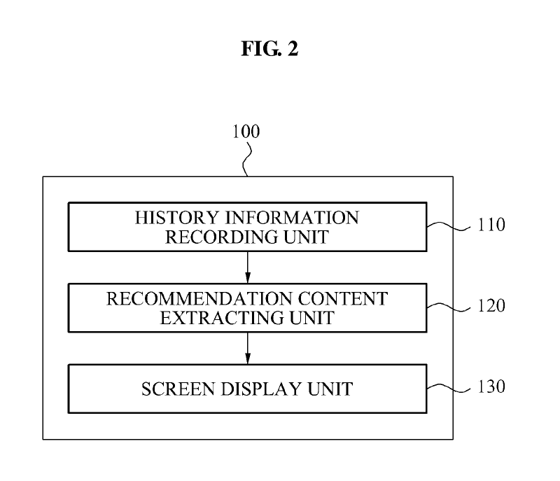

FIG. 2 illustrates an example of content recommendation apparatus. Referring to FIG. 2, the content recommendation apparatus 100 includes a history information recording unit 110, a recommendation content extracting unit 120, and a display unit 130.

The history information recording unit 110 records personal status information that may include a current location, a current time, personal activities, emotions, and the like, of an individual user of the apparatus. The history information recording unit 110 may record a web log of the user using, for example, a web browsing service terminal, a phone log of the mobile communication terminal, and the like.

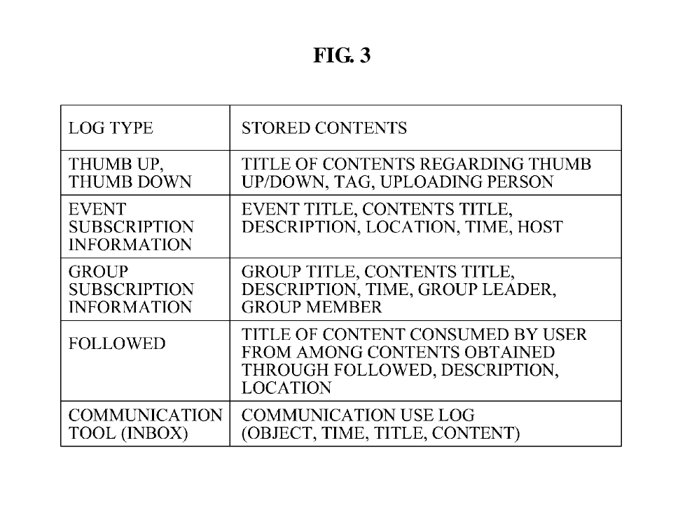

FIG. 3 is a table that illustrates examples of web log types and contents of the web logs. Referring to the examples shown in FIG. 3, if the type of the web log is a “thumbs up & thumbs down” web log, the stored contents may include, for example, a title of contents regarding “thumbs up & thumbs down,” a tag, a person who uploads contents, and the like. If the type of the web log is an “event subscription information,” for example, the stored contents may include an event title, a content title, a description, a location, a time, a host, and the like.

If the type of the web log is a “group subscription information,” the stored contents may include, for example, a group title, a content title, a description, a time, a group host, a group member, and the like. If the type of the web log is “followed,” the stored contents may include, for example, a title of a content consumed by a user from among contents obtained through “followed,” a description, a location, and the like. If the type of the web log is a “communication tool (inbox),” the stored contents may include, for example, an object of the communication, a time of the communication, a title of the communication, a content, and the like.

In the example of “thumbs up & thumbs down,” when a user agrees with a corresponding content, a user may click on “thumbs up,” or if the user disagrees the user may click on “thumbs down.” Accordingly, “thumbs up & thumbs down” may be stored as preference information of the user, and may be used for recommendation of a group or an event.

In another example, the contents stored in a “communication tool,” such as an inbox, may be used for arrangement of a friend list, and the title and content of “communication tool” may be stored as the preference information of the user.

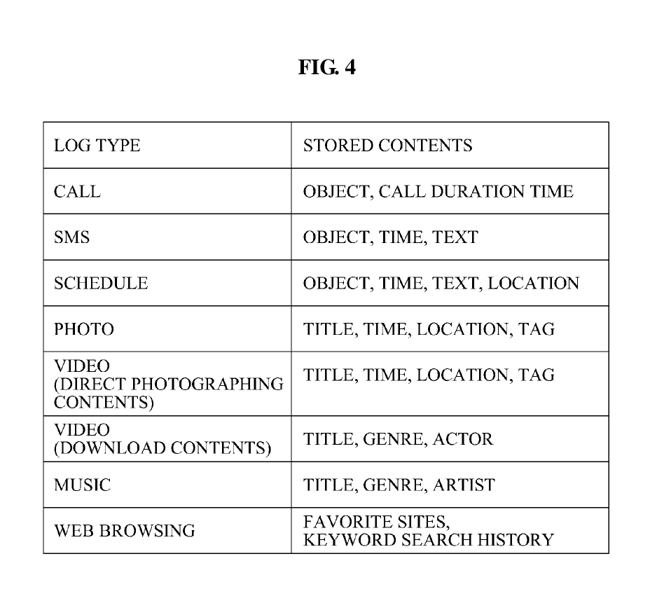

FIG. 4 is a table that illustrates examples of phone log types and contents of the phone logs. Referring to FIG. 4, the log type may include, for example, a phone log, a “call,” a “Short Message Service (SMS),” a “schedule,” a “photo,” a “video (direct photographing contents),” a “video (download contents),” “music,” and “web browsing.” In the example of the mobile communication terminal, an object and a call duration time of the “call” may be stored in a “call” log, and an object, a time, and a text of an “SMS” may be stored in an “SMS” log.

In another example, an object, a time, a location, and a text of a “schedule” may be stored in a “schedule” log, and a title, a time, a location, and a tag of “photo” may be stored in a “photo” log. A title, a time, a location, and a tag of the direct photographing contents may be stored in “Video” log. A title, a genre, and an actor of downloaded contents may be stored in a “Video” log. a title, a genre, an artist of “music” may be stored in a “music” log. Also, favorite sites and a keyword search history of “web browsing” may be stored in a “web browsing” log.

Referring again to FIG. 2, the recommendation content extracting unit 120 may generate the preference information of the user based on the web log and the phone log. For example, the recommendation content extracting unit 120 may use fields such as “keyword,” “user,” “location,” and “time” of the web log and the phone log, may be used to generate preference information of the user of the apparatus.

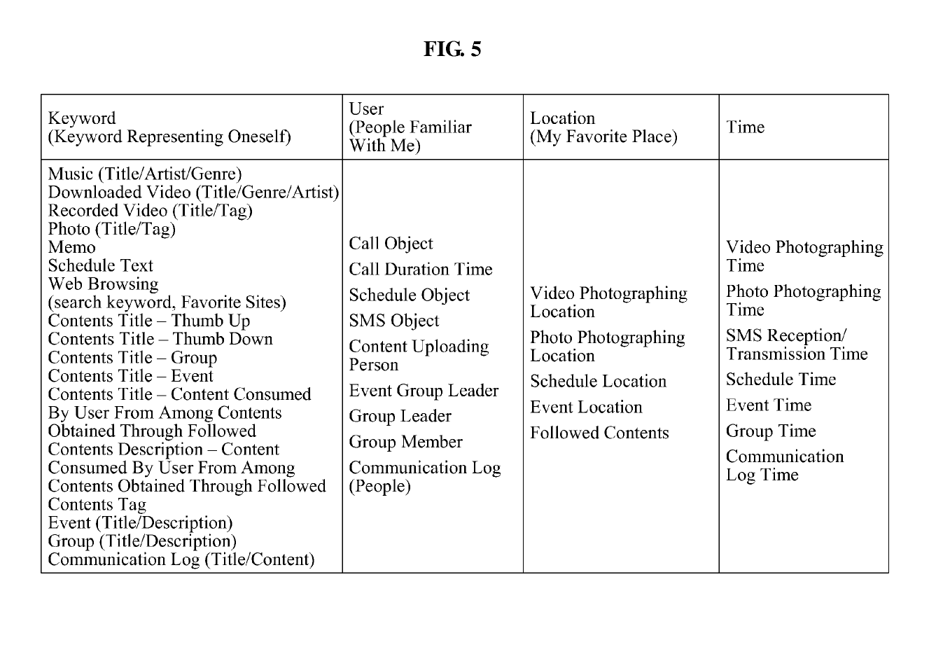

FIG. 5 is a table that illustrates examples of fields based on preferences used in a preference information generating unit. Referring to FIG. 5, the “keyword” field may include, for example, the title/artist/genre of music, the title/genre/artist of a downloaded video, the title/tag of a recorded video, the title/tag of a photo, a memo, a schedule text, content titles of a web browsing (thumbs up, thumbs down, a group, an event, a content consumed by a user from among contents obtained through “followed,” contents description, contents tag, title/description of an event, title/description of a group, title/content of a communication log, and the like.

The “user” field may include, for example, a call object, a call duration time, a schedule object, an SMS object, a person who uploads contents, an event group leader, a group leader, a group member, a communication log, and the like.

The “location” field may include, for example, a video photographing location, a photo photographing location, a schedule location, an event location, a followed content location, and the like.

The “time” field may include, for example, a video photographing time, a photo photographing time, an SMS reception/transmission time, a schedule time, an event time, a group time, a communication log time, and the like.

The recommendation content extracting unit 120 may generate the preference information of the user by classifying log information of the user into the examples of the above described fields. For example, based on a communication log such as a call, an SMS, an e-mail, and the like, information such as names of acquaintances arranged in accordance with a friend list may be reflected in the preference information. The time, location, and texts of a schedule function may be reflected in the preference information, or a title tag of multimedia contents may be reflected in the preference information.

The content recommendation apparatus may integrate user history information as source data upon which preference information for content recommendation may be generated. The preference information may be generated regardless of the type of a personal communication terminal, and display the recommendation contents in a user-friendly manner, for example, in a visually accessible type.

For example, a user may directly download coupons of a corresponding shopping center using the content recommendation apparatus. Also, when the user enters a particular area, introductions of recommendable restaurants of the area may be provided to the user through the content recommendation apparatus, and when an event such as street performance occurs, various recommendation contents such as information about the event may be provided. Selection and non-selection of the user with respect to the recommendation contents may be recorded again in the user history information to be stored and/or fed back as preference information.

Referring again to FIG. 2, the recommendation content extracting unit 120 may extract the recommended contents based on the status information of the user and the preference information transmitted from the history information recording unit 110. For example, the recommendation content extracting unit 120 may extract the recommended contents further based on the popularity of the contents with respect to a plurality of other users.

The display unit 130 may categorize the recommended contents into a category including, for example, an event, a group, a friend, “my stuff,” followed, an inbox, and the like. For example, the category may be stored in the personal communication terminal to be provided, or designated by a user.

The recommended contents classified into the category may be displayed by changing a size and a color of the recommended contents, to visually differentiate the contents based on the preference information of the user and the category.

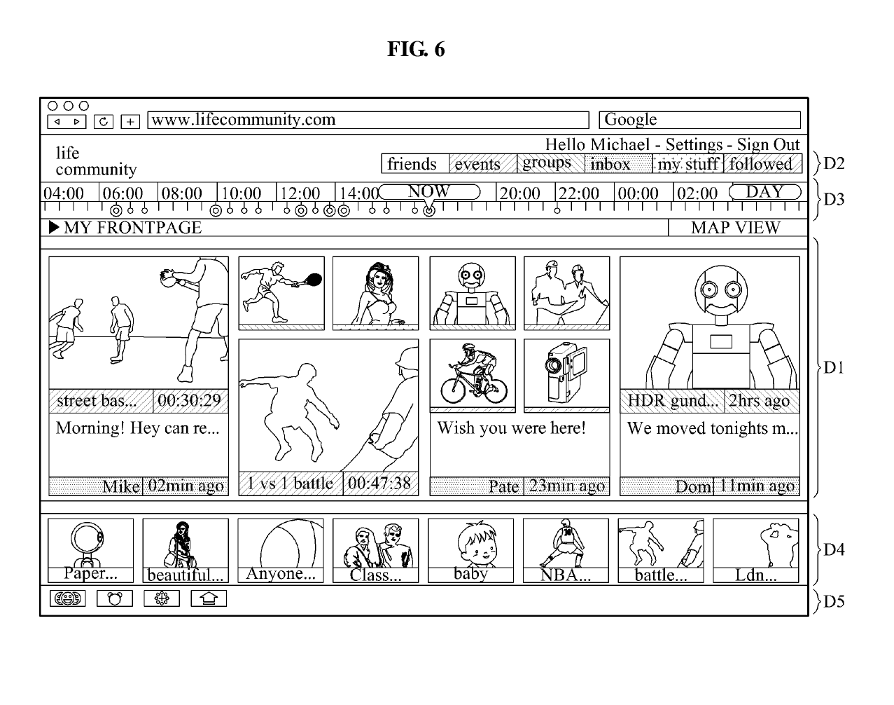

FIG. 6 illustrates an example of recommended contents displayed on the display of a web browsing terminal. Referring to FIG. 6, the recommended contents may be displayed in a D1 region that corresponds to an approximate middle portion of the display. The recommended contents may be generated and displayed as content grids having different sizes in proportion to the preference information of the user such as major, moderate, and/or small. The recommended contents may be displayed, for example, to have different colors based on category type, thereby enabling a user to readily recognize the category of the recommended contents. The category may be displayed on the display as a separate icon, so that the user may easily recognize the category having different colors.

For example, the recommended contents may be arranged from left to right or from right to left in chronological order to enable the user to easily recognize the chronological order.

Referring to the example shown in FIG. 6, the phrase “street basket” may be displayed as a major content grid and arranged to the leftmost in the D1 region, the phrase “1 vs. 1 battle” may be displayed as another major content grid and arranged next to the phrase “street basket.” The phrase “HDR gundam” may be displayed as another major content grid and arranged to the rightmost in the D1 region. In this example, the most preferable contents of the user are displayed on the rightmost side of the display.

In addition, the phrase “street basket” and “1 vs. 1 battle” may be displayed as a specific color, for example recommended contents corresponding to an “events” category may be displayed as a purple color and may be included in categories of a D2 region. For example, the phrase “HDR gundam” may be displayed as another specific color, for example, a yellow color and may be included in a “groups” category of the D2 region.

In the example arrangement of the recommended contents included in the above three major content grids, a most recently recommended content may be arranged to the rightmost in the D1 region based on chronological order. That is, the phrase “HDR gundam” may be the most recent content generated before two hours, the phrase “1 vs. 1 battle” may be a content generated at 00:47:38, and the phrase “street basket” may be a content generated at 00:30:29, and may correspond to the oldest content of the three contents.

The terms Mike, Pate, and Dom that correspond to a moderate content grid may be displayed as another specific color, for example a green color, and may be included in an “inbox” category of the D2 region that also has the green color. For example, the terms Mike, Pate, and Dom may be arranged to the rightmost in the D1 region based on the chronological order.

In addition, the recommended contents included in the small content grid may be shown in the D1 region, may have different colors for each category, and may be arranged from right to left based on the chronological order.

In a D3 region shown in FIG. 6, a current location and a current time of the user may be shown. For example, the current time of the user may be displayed as “NOW,” and the current location of the user may be displayed as “LONDON.” The current time and the current location of the user may be used to designate the recommended contents, and the preference information may be obtained based on the current time and the current location to extract the recommended contents.

If one of the recommended contents is selected by the user, recommended contents similar to the selected recommended content may be additionally shown in a More Like This (MLT) region as shown in the D4 region. Accordingly, the recommendation content extracting unit may further extract the recommended contents similar to the selected recommended content, and the display unit may further display the similarly recommended content. For example, the display unit may display the similarly recommended content below the recommendation content grids in chronological order.

In a D5 region of FIG. 6, icons, for example, a friends icon, a create event icon, a group icon, an upload contents icon, and the like, may be shown as optionally provided icons. These icons may be provided in a pop-up type, when being clicked on.

Accordingly, a user of the content recommendation apparatus may receive communication such as messages, calls, texts, and the like, from various other people. The contents may be generated and displayed in various shapes, sizes, colors, and the like, to indicate the content of the communication, based on user preferences and/or user history information. The contents may be displayed in chronological order. In addition, various contents may be recommended by the content recommendation apparatus based on the user preferences, user history information, and/or user selections.

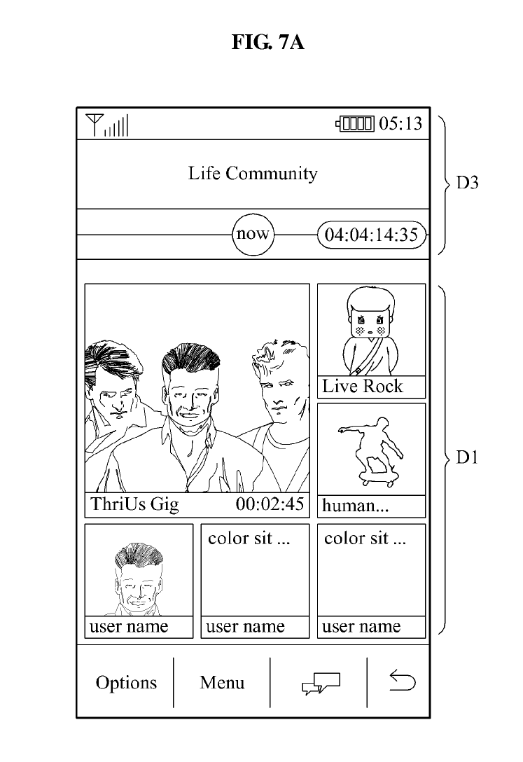

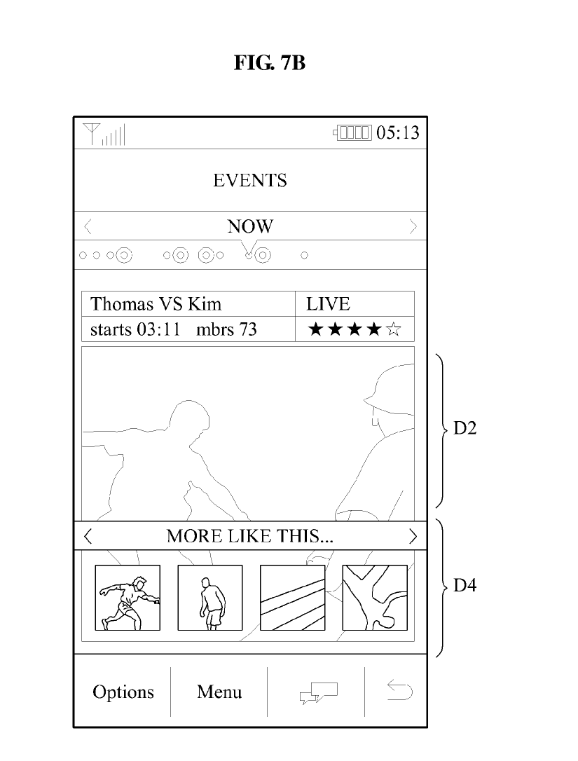

FIGS. 7A and 7B illustrate examples of recommended contents displayed on the display of a mobile terminal

Referring to the example shown in FIG. 7A, six recommended contents are currently displayed. The number of recommended contents displayed may be based on the size of the display of the mobile communication terminal. For example, one recommended content may be displayed as a major recommendation content grid, and the other five recommended contents may be displayed as a small recommendation content grid, as shown in this example.

In the D3 region of FIG. 7A, current status information of a user including time information and location information may be displayed. However, due to the limitation in the size of the display, the D2, D4, and D5 regions of FIG. 6 may not be shown in the display of FIG. 7. However, when one of the recommended contents is selected by a user, similarly recommended contents corresponding to the selected recommended content may be displayed through a next depth movement.

FIG. 7B shows similarly recommended contents of the above described MLT region. Referring to FIG. 7B, four similarly recommended contents with respect to the recommendation content selected in the D2 region are shown. For example, the similarly recommended contents may be arranged below the corresponding recommended content in chronological order. For example, as shown in FIG. 7B, the most recent recommendation content may be arranged to the rightmost in the D4 region.

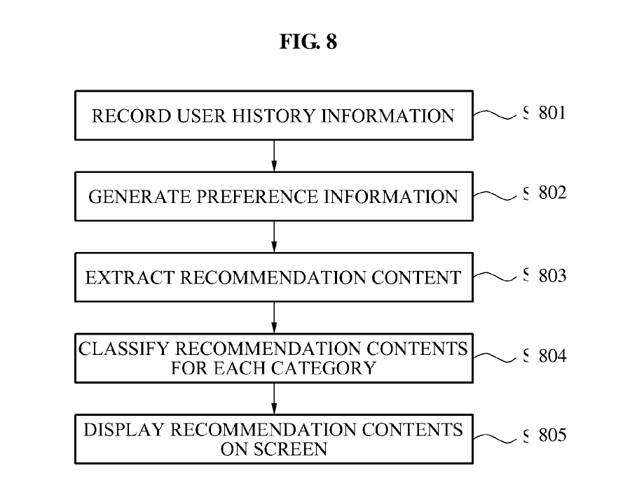

FIG. 8 is a flowchart that illustrates an example of a content recommendation method. Referring to FIG. 8, in operation 801, the content recommendation method in a communication environment where a communication device such as a web browsing service terminal and/or the mobile communication terminal are integrated may record history information of a user using the web browsing service terminal and the mobile communication terminal. For example, the communication device may record a web log of the user using the web browsing service terminal, and/or a phone log of the user using the mobile communication terminal.

In operation 802, the content recommendation method may generate preference information of the user based on the history information. In 803, the content recommendation method may extract recommended contents based on the preference information of the user. In operation 804, the content recommendation method may classify the recommended contents by category. In operation 805, the content recommendation method may display the classified recommendation contents on a display in a visually different manner depending on the preference information of the user and the category type.

For example, in operation 803, the content recommendation method may extract the recommendation contents further based on the status information of the user and a popularity of the recommended contents with respect to a plurality of other users.

As described above, the content recommendation apparatus and method may collect related contents based on the history information of the user and generate user preference information, and recommend desired contents based on accumulated history information and/or preference information. For example, the content recommendation apparatus and method may classify the preference information of the user into a keyword field (meta information), a user field, a location field, and a time field, and recommend contents further based on current status information of the user. As a result, customized recommended contents for the user may be configured, the user may easily and quickly access desired information.

The content recommendation apparatus and method may flexibly adjust the size and color of the recommendation content grids of the customized recommended contents based on the preference information of the user to thereby configure an entire display in a user-friendly manner.

The content recommendation apparatus may retrieve information based on a popularity of users. The content recommendation apparatus may enable an individual user to manage contents for each category. The content recommendation apparatus may enable an individual user to manage favorite contact people.

As a non-exhaustive illustration only, the terminal device described herein may refer to mobile devices such as a cellular phone, a personal digital assistant (PDA), a digital camera, a portable game console, an MP3 player, a portable/personal multimedia player (PMP), a handheld e-book, a portable lab-top personal computer (PC), a global positioning system (GPS) navigation, and devices such as a desktop PC, a high definition television (HDTV), an optical disc player, a setup box, and the like, capable of wireless communication or network communication consistent with that disclosed herein.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer.

It should be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

The above described methods may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable storage media include magnetic media such as hard disks, floppy disks, and magnetic tape; optical media such as CD-ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A content recommendation apparatus, comprising:
a history information recording unit configured to record user history information of a user of a personal communication terminal comprising at least one of a web browsing service or in which mobile communication is possible;
a recommendation content extracting unit configured to generate preference information of the user based on the user history information, and to extract recommended content based on the preference information; and
a display unit configured to display the recommended content by category type based on the preference information of the user such that the recommended content is visually differentiated by category type.

2. The content recommendation apparatus of claim 1, wherein the user history information comprises at least one of a current time, a current location of the user, web log information, and phone log information.

3. The content recommendation apparatus of claim 1, wherein the recommendation content extracting unit is further configured to extract the recommended content further based on a popularity of the recommended content with respect to a plurality of other users.

4. The content recommendation apparatus of claim 1, wherein the category type comprises at least one of event, group, friend, “my stuff,” followed, and inbox.

5. The content recommendation apparatus of claim 1, wherein the category type is provided by the personal communication terminal, or determined by the user.

6. The content recommendation apparatus of claim 1, wherein the display unit is further configured to generate and display the recommended content in grids having different sizes based on the preference information.

7. The content recommendation apparatus of claim 1, wherein the display unit is further configured to display a current location and a current time of the user.

8. The content recommendation apparatus of claim 1, wherein the display unit is further configured to arrange the most recent recommended content in a rightmost area of the display, with respect to the other arranged recommended contents.

9. The content recommendation apparatus of claim 1, wherein
the content extracting unit is further configured to extract recommended content that is similar to recommended content selected by the user; and
the display unit is further configured to display the similarly recommended content.

10. The content recommendation apparatus of claim 9, wherein the display unit is further configured to display the similarly recommended content in chronological order below a recommendation content grid.

11. A content recommendation method, comprising:
recording user history information of a user of a personal communication terminal comprising at least one of a web browsing service or in which mobile communication is possible;
generating preference information of the user based on the user history information;
extracting a recommended content based on the preference information;
categorizing the recommendation content by category type; and
displaying, on a display, the recommended content based on the preference information.

12. The content recommendation method of claim 11, wherein the user history information comprises at least one of a current time, a current location of the user, web log information, and phone log information.

13. The content recommendation method of claim 11, wherein the extracting extracts the recommended content further based on a popularity of the recommended content with respect to a plurality of other users.

14. The content recommendation method of claim 11, wherein the category type comprises at least one of event, group, friend, my stuff, followed, and inbox.

15. The content recommendation method of claim 11, wherein the category type is provided by the personal communication terminal, or configured by the user.

16. The content recommendation method of claim 11, wherein the displaying generates and displays the recommended content in grids having different sizes based on the preference.

17. The content recommendation method of claim 11, wherein the displaying displays a current location and a current time of the user.

18. The content recommendation method of claim 11, wherein the displaying arranges the most recent recommended content in a rightmost area of display, with respect to the other arranged recommended contents.

19. The content recommendation method of claim 11, wherein the extracting further extracts recommended content that is similar to recommended content selected by the user, and the displaying further displays the similarly recommended content.

20. The content recommendation method of claim 19, wherein the displaying displays the similarly recommended content in chronological order below a recommendation content grid.

21. A non-transitory computer-readable storage medium having stored therein program instructions to cause a processor to execute a content recommendation method, comprising:
recording user history information of a user of a personal communication terminal comprising at least one of a web browsing service or in which mobile communication is possible;
generating preference information of the user based on the user history information;
extracting a recommended content based on the preference information;
categorizing the recommendation content by category type; and
displaying, on a display, the recommended content based on the preference information.
